(19) United States
(12) Patent Application Publication
(10) Pub. No.: US 2024/0194966 A1
(43) Pub. Date: Jun. 13, 2024

(54) BATTERY THERMAL SUPPRESSION SYSTEMS

(71) Applicant: FORD GLOBAL TECHNOLOGIES, LLC, Dearborn, MI (US)

(72) Inventors: Brian Utley, Canton, MI (US); Bhaskara Rao Boddakayala, Troy, MI (US)

(21) Appl. No.: 18/154,398

(22) Filed: Jan. 13, 2023

Related U.S. Application Data
(60) Provisional application No. 63/386,986, filed on Dec. 12, 2022.

(51) Int. Cl. H01M 10/625; H01M 10/613; H01M 10/6561

(52) U.S. Cl. CPC H01M 10/625; H01M 10/613; H01M 10/6561; H01M 2220/20

(57) ABSTRACT

Battery thermal suppression systems are provided for battery arrays and/or traction battery packs. Exemplary thermal suppression systems may include one or more aerosol devices that are adapted to release potassium (K) radicals when the material temperature reaches a predefined temperature threshold, thereby mitigating the effects of battery thermal events. The aerosol devices may be passive devices that can be implemented at the battery array level, the battery pack level, or both. Each aerosol device may be mounted in relatively close proximity to but without touching the battery cells of the battery array/battery pack.

### CROSS-REFERENCE TO RELATED APPLICATIONS

This disclosure claims priority to U.S. Provisional Application No. 63/386,986, which was filed on Dec. 12, 2022 and is incorporated herein by reference.

### TECHNICAL FIELD

This disclosure relates generally to electrified vehicle traction battery packs, and more particularly to thermal suppression systems for managing battery thermal events.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A thermal suppression system for a traction battery pack according to an exemplary aspect of the present disclosure includes, among other things, a battery array including a plurality of battery cells, and an aerosol device positioned in a non-contiguous manner with respect to each battery cell of the plurality of battery cells.

In a further non-limiting embodiment of the foregoing thermal suppression system, the aerosol device is a sheet-like structure that includes a polymeric encapsulating material and a potassium aerosol encapsulated within the polymeric encapsulating material.

In a further non-limiting embodiment of either of the foregoing thermal suppression systems, the potassium aerosol is configured to release an aerosol cloud containing potassium radicals when a predefined temperature threshold is exceeded.

In a further non-limiting embodiment of any of the foregoing thermal suppression systems, the aerosol device is attached to a battery array structure of the battery array.

In a further non-limiting embodiment of any of the foregoing thermal suppression systems, the aerosol device is attached to a top plate of the battery array structure.

In a further non-limiting embodiment of any of the foregoing thermal suppression systems, the aerosol device is attached to a side plate of the battery array structure.

In a further non-limiting embodiment of any of the foregoing thermal suppression systems, an adhesive bonds the aerosol device to the battery array structure.

In a further non-limiting embodiment of any of the foregoing thermal suppression systems, the aerosol device is attached to an interior wall of an enclosure cover or an interior wall of an enclosure tray of the traction battery pack.

In a further non-limiting embodiment of any of the foregoing thermal suppression systems, the aerosol device is attached to an interior wall of an enclosure cover. A second aerosol device is attached to an interior wall of an enclosure tray.

In a further non-limiting embodiment of any of the foregoing thermal suppression systems, a gap extends between the aerosol device and the battery array.

A traction battery pack according to another exemplary aspect of the present disclosure includes, among other things, an enclosure assembly, a plurality of battery arrays housed within the enclosure assembly, and a thermal suppression system including a plurality of aerosol devices mounted to at least one interior surface of the enclosure assembly. Each of the plurality of aerosol devices includes a polymeric encapsulating material and a potassium aerosol encapsulated within the polymeric encapsulating material.

In a further non-limiting embodiment of the foregoing traction battery pack, each of the plurality of aerosol devices is positioned in a non-contiguous manner with respect to each battery array of the plurality of battery arrays.

In a further non-limiting embodiment of either of the foregoing traction battery packs, a gap extends between each of the plurality of aerosol devices and each battery array of the plurality of battery arrays.

In a further non-limiting embodiment of any of the foregoing traction battery packs, the potassium aerosol is configured to release an aerosol cloud containing potassium radicals when a predefined temperature threshold is exceeded.

In a further non-limiting embodiment of any of the foregoing traction battery packs, each of the plurality of aerosol devices is a heat activated, sheet-like structure.

In a further non-limiting embodiment of any of the foregoing traction battery packs, the at least one interior surface is part of an enclosure cover of the enclosure assembly.

In a further non-limiting embodiment of any of the foregoing traction battery packs, the at least one interior surface is part of an enclosure tray of the enclosure assembly.

In a further non-limiting embodiment of any of the foregoing traction battery packs, a first aerosol device of the plurality of aerosol devices is mounted to an enclosure cover, and a second aerosol device of the plurality of aerosol devices is mounted to an enclosure tray.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows

### BRIEF DESCRIPTION OF THE DRAWINGS

FIG. 1 schematically illustrates an electrified vehicle.

FIG. 2 illustrates an exemplary thermal suppression system for a battery array.

FIG. 3 illustrates an aerosol device of the thermal suppression system of FIG. 2.

FIG. 4 illustrates the aerosol device of FIG. 3 during a battery thermal event.

FIG. 5 illustrates an exemplary thermal suppression system for a traction battery pack.

### DETAILED DESCRIPTION

This disclosure details exemplary battery thermal suppression systems for battery arrays and/or traction battery packs. Exemplary thermal suppression systems may include one or more aerosol devices that are adapted to release potassium (K) radicals when the material temperature reaches a predefined temperature threshold, thereby mitigating the effects of battery thermal events. The aerosol devices may be passive devices that can be implemented at the battery array level, the battery pack level, or both. Each aerosol device may be mounted in relatively close proximity to but without touching the battery cells of the battery array/battery pack. These and other features are discussed in greater detail in the following paragraphs of this detailed description.

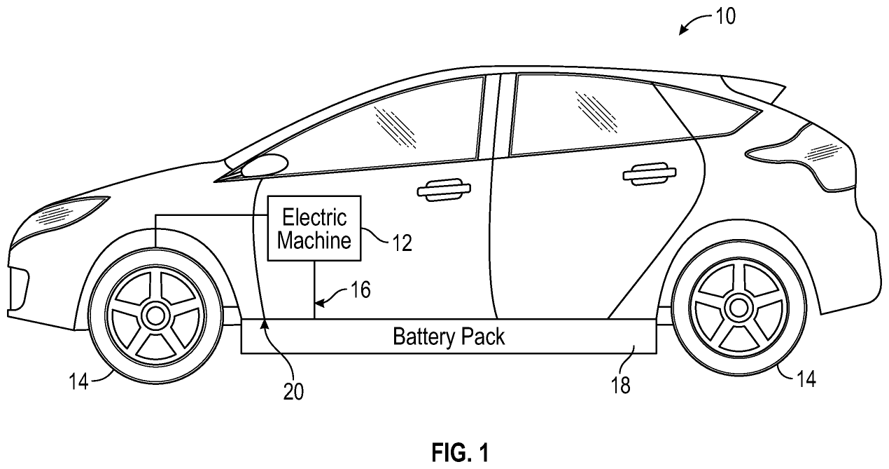

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

From time to time, one or more battery cells of the traction battery pack 18 can experience a battery thermal event in which pressure and thermal energy of the one or more battery cells increases. The pressure and thermal energy increases can be due to an overcharge condition, an overdischarging condition, or a short circuit event, for example. The pressure and thermal energy increases can cause the battery cell experiencing the thermal event to release gas and/or other effluents. The gases/effluents may be released as a result of an applied force or a thermal event, and can either cause or exacerbate an existing battery thermal event. A relatively significant amount of heat can be generated during battery thermal events, and this heat can sometimes cascade from cell-to-cell and/or from array-to-array within the traction battery pack 18. This disclosure is therefore directed to traction battery pack and/or battery array designs that incorporate thermal suppression systems for mitigating the effects of battery thermal events.

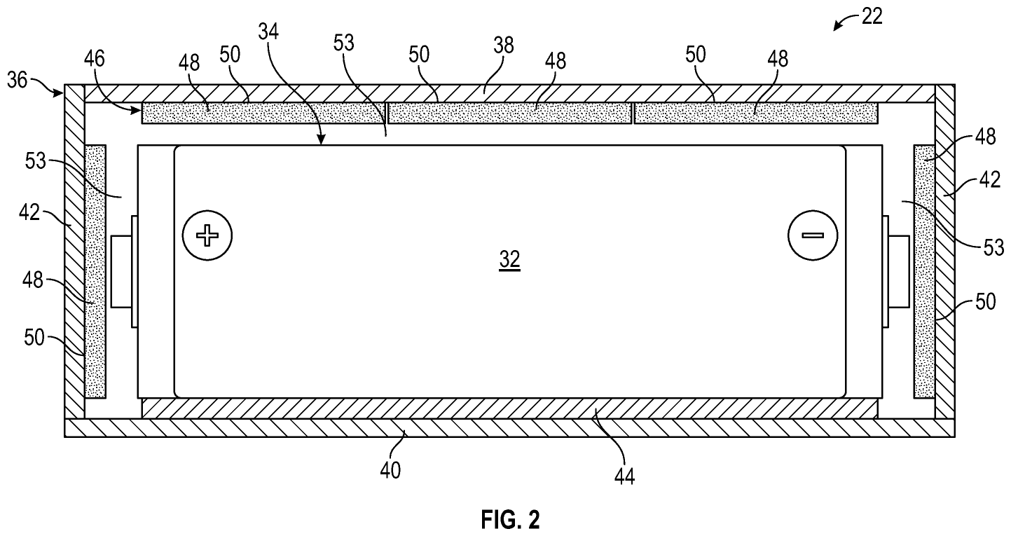

FIG. 2 illustrates an exemplary battery array 22 for a traction battery pack, such as the traction battery pack 18 of the electrified vehicle 10 of FIG. 1, for example. As explained in further detail below, the battery array 22 may incorporate thermal suppressant aerosol features designed for slowing combustion and reducing heat release rates during battery thermal events.

The battery array 22 may include a plurality of battery cells 32. The total number of battery cells 32 provided within the battery array 22 may vary and is not intended to limit this disclosure. The battery cells 32 may be grouped together in a cell stack 34. In the illustrated embodiment, the battery cells 32 of the cell stack 34 are arranged together along a stack axis that extends into the page.

In an embodiment, the battery cells 32 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

An array support structure 36 may be arranged to substantially surround the cell stack 34. In an embodiment, the array support structure 36 completely encloses the cell stack 34. The array support structure 36 may include a top plate 38, a bottom plate 40, a pair of side plates 42, and a pair of end plates (not shown in the cross-sectional end view of FIG. 2).

The bottom plate 40 of the array support structure 36 may be arranged to function as a liquid cooled heat exchanger plate or “cold plate” of the battery array 22. For example, the bottom plate 40 may be part of a liquid cooling system that is configured for circulating a coolant, such as water mixed with ethylene glycol or any other suitable coolant, through an interior cooling circuit of the bottom plate 40. The coolant may pick up heat that is generated within the battery cells 32 as it circulates through the internal cooling circuit of the bottom plate 40. A thermal interface material 44 (e.g., epoxy resin, silicone based materials, thermal greases, etc.) may be disposed between the battery cells 32 of the cell stack 34 and the bottom plate 40 for facilitating heat transfer therebetween.

The battery array 22 may further include a thermal suppression system 46 for mitigating the effects of battery thermal events. The thermal suppression system 46 may include one or more aerosol devices 48 that are designed for passively responding to battery thermal events by reducing the oxygen content of the air in or around the battery array 22. As discussed in greater detail below, each aerosol device 48 may be configured to release potassium (K) radicals when the temperature at or near the battery array 22 exceeds a predefined temperature threshold in the event of a battery thermal event.

In some implementations, the aerosol devices 48 may be configured as sheet-like structures. In other implementations, the aerosol devices 48 could be configured as a coating. In still other implementations, the aerosol devices 48 may be configured in a rope format, or as a pad, block, or puck.

Each aerosol device 48 may be mounted or secured directly to the array support structure 36. The aerosol devices 48 may be bonded to the array support structure 36 via an adhesive 50, such as double-sided adhesive tape, for example. In an embodiment, a portion of the aerosol devices 48 are mounted to the top plate 38, and another portion of the aerosol devices 48 are mounted to the pair of side plates 42. The aerosol devices 48 of the thermal suppression system 46 may therefore be positioned above and to the sides of the battery cells 32 of the cell stack 34. However, other configurations are further contemplated within the scope of this disclosure.

A gap 53 may extend between each aerosol device 48 and the cell stack 34. The aerosol devices 48 are therefore mounted in close proximity to the cell stack 34 but in a non-contiguous manner (e.g., not touching) relative to each battery cell 32 of the cell stack 34.

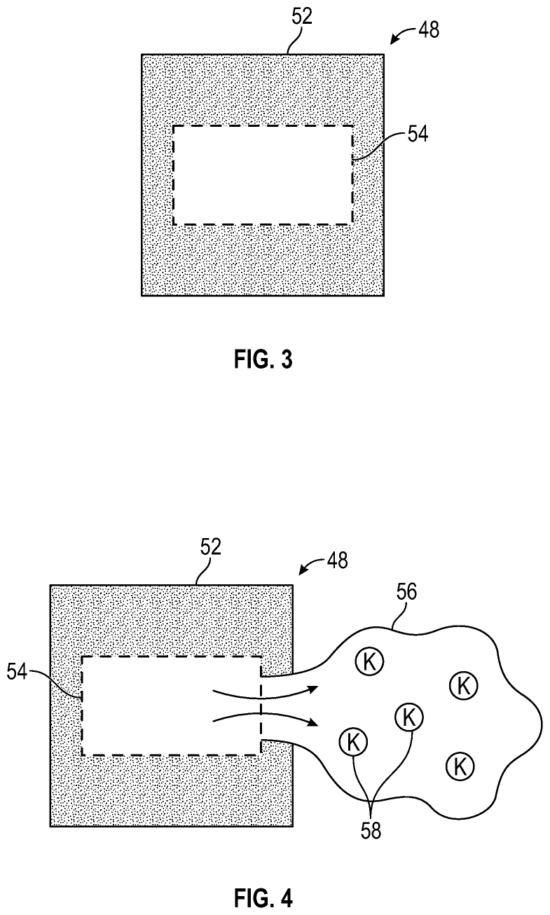

Referring now to FIGS. 3-4 (with continued reference to FIG. 2), each aerosol device 48 may include a polymeric encapsulating material 52 and a potassium aerosol 54 encapsulated within the polymeric encapsulating material 52. In an embodiment, the polymeric encapsulating material 52 is configured as a polyethylene laminated pouch. However, other geometries and materials are contemplated within the scope of this disclosure, and therefore the size, shape, and material make-up of the polymeric encapsulating material 52 is not intended to limit this disclosure.

The potassium aerosol 54 may be contained inside the polymeric encapsulating material 52 during normal conditions of the battery array 22 (see FIGS. 2-3). The potassium aerosol 54 may be heat activated to release an aerosol cloud 56 containing potassium radicals 58 (see FIG. 4). For example, when a predefined temperature threshold (e.g., about 250 degrees C.) of the material of the potassium aerosol 54 is reached due to a temperature increase inside the battery array 22, the potassium aerosol 54 may release the aerosol cloud 56 containing the potassium radicals 58. The potassium radicals 58 may bond with gaseous oxygen to effectively reduce the oxygen content inside the battery array 22, thereby hindering combustion and reducing heat release rates associated with the battery thermal event.

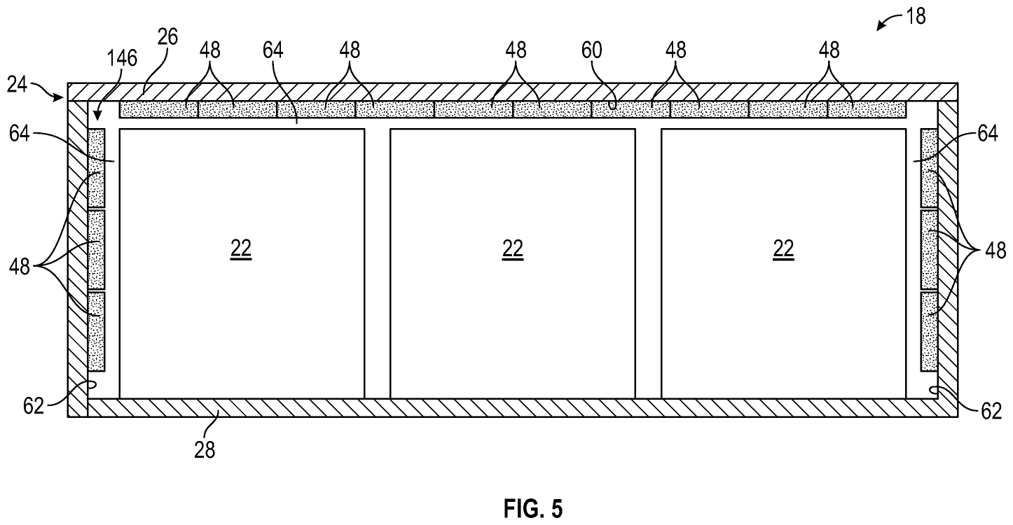

The thermal suppression system 46 described above is implemented at the battery array level. However, in other embodiments, a thermal suppression system could be implemented at the traction battery pack level. FIG. 5 illustrates one such “battery pack level” implementation.

Referring now specifically to FIG. 5, a traction battery pack 18 may include a plurality of battery arrays 22 housed within an interior area established by an enclosure assembly 24. Although the traction battery pack 18 of FIG. 5 is depicted as having three battery arrays, the traction battery pack 18 could be provided with a greater or fewer number of battery arrays within the scope of this disclosure. Each battery array 22 may include a plurality of battery cells.

The traction battery pack 18 may further include a thermal suppression system 146 for mitigating the effects of battery thermal events. The thermal suppression system 146 may include one or more aerosol devices 48 that may each be configured to release aerosol particles in the event of a battery thermal event. The aerosol devices 48 may be mounted to an interior surface 60 of an enclosure cover 26 and/or to an interior surface 62 of an enclosure tray 28 of the enclosure assembly 24.

A gap 64 may extend between each aerosol device 48 and the battery arrays 22. The aerosol devices 48 are therefore mounted in close proximity to each battery array 22 but in a non-contiguous manner (e.g., not touching) relative to each battery array 22. The specific placement of each aerosol device 48 is not intended to limit this disclosure. In an exemplary embodiment, each aerosol device 48 may include the design of the aerosol device shown in FIGS. 3-4.

The exemplary battery thermal suppression systems of this disclosure are designed to mitigate or even prevent thermal runaway and other effects of battery thermal events. Among other benefits, the proposed thermal suppression systems allow for increased energy density and increased installation flexibility.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A thermal suppression system for a traction battery pack, comprising:
a battery array including a plurality of battery cells; and
an aerosol device positioned in a non-contiguous manner with respect to each battery cell of the plurality of battery cells.

2. The thermal suppression system as recited in claim 1, where the aerosol device is a sheet-like structure that includes a polymeric encapsulating material and a potassium aerosol encapsulated within the polymeric encapsulating material.

3. The thermal suppression system as recited in claim 2, wherein the potassium aerosol is configured to release an aerosol cloud containing potassium radicals when a predefined temperature threshold is exceeded.

4. The thermal suppression system as recited in claim 1, wherein the aerosol device is attached to a battery array support structure of the battery array.

5. The thermal suppression system as recited in claim 4, wherein the aerosol device is attached to a top plate of the battery array support structure.

6. The thermal suppression system as recited in claim 4, wherein the aerosol device is attached to a side plate of the battery array support structure.

7. The thermal suppression system as recited in claim 4, comprising an adhesive that bonds the aerosol device to the battery array support structure.

8. The thermal suppression system as recited in claim 1, wherein the aerosol device is attached to an interior wall of an enclosure cover or an interior wall of an enclosure tray of the traction battery pack.

9. The thermal suppression system as recited in claim 1, wherein the aerosol device is attached to an interior wall of an enclosure cover, and comprising a second aerosol device attached to an interior wall of an enclosure tray.

10. The thermal suppression system as recited in claim 1, wherein a gap extends between the aerosol device and the battery array.

11. A traction battery pack, comprising:
an enclosure assembly;
a plurality of battery arrays housed within the enclosure assembly; and
a thermal suppression system including a plurality of aerosol devices mounted to at least one interior surface of the enclosure assembly,
wherein each of the plurality of aerosol devices includes a polymeric encapsulating material and a potassium aerosol encapsulated within the polymeric encapsulating material.

12. The traction battery pack as recited in claim 11, wherein each of the plurality of aerosol devices is positioned in a non-contiguous manner with respect to each battery array of the plurality of battery arrays.

13. The traction battery pack as recited in claim 12, wherein a gap extends between each of the plurality of aerosol devices and each battery array of the plurality of battery arrays.

14. The traction battery pack as recited in claim 11, wherein the potassium aerosol is configured to release an aerosol cloud containing potassium radicals when a predefined temperature threshold is exceeded.

15. The traction battery pack as recited in claim 11, wherein each of the plurality of aerosol devices is a heat activated, sheet-like structure.

16. The traction battery pack as recited in claim 11, wherein the at least one interior surface is part of an enclosure cover of the enclosure assembly.

17. The traction battery pack as recited in claim 11, wherein the at least one interior surface is part of an enclosure tray of the enclosure assembly.

18. The traction battery pack as recited in claim 11, wherein a first aerosol device of the plurality of aerosol devices is mounted to an enclosure cover, and a second aerosol device of the plurality of aerosol devices is mounted to an enclosure tray.
